(19) United States
(12) Patent Application Publication
(10) Pub. No.: US 2007/0006697 A1
(43) Pub. Date: Jan. 11, 2007

(54) Self-aligning blade holder

(76) Inventor: Leonard L. Ivel, Leicester, MA (US)

Correspondence Address: ROBERT W. BECKER & ASSOCIATES, 707 HIGHWAY 333, SUITE B, TIJERAS, NM, 87059-7507, US

(21) Appl. No.: 11/179,054

(22) Filed: Jul. 11, 2005

(51) Int. Cl. B26D 1/00

(52) U.S. Cl. 83/13; 83/284

(57) ABSTRACT

A device and method for aligning the axis of rotation of a blade parallel to the axis of rotation of an anvil roll, including a blade support for rotatably holding the blade, wherein the blade support is pivotable relative to a pivot axis to effect parallel alignment of the axes. The pivot axis is disposed essentially perpendicular to the axis of rotation of the anvil roll and upstream of a contact point of the blade with the anvil roll as viewed in a direction of passage of material between the blade and the anvil roll.

### BACKGROUND OF THE INVENTION

The present invention relates to a device and method for aligning the axis of a blade with an axis of an anvil roll.

In the field of crush or score cutting, two primary elements are involved in the process, namely the score or crush cut blade or knife, and the anvil roll. Both components have a circular cross-section and both are designed to rotate on parallel axes. The blade, with a relatively sharp outer periphery, is pressed against the smooth anvil roll with a force substantial enough to crush or score, and hence cut, the material that is being processed as such material passes between the two components. The material of the anvil roll and of the blade or knife is typically hardened steel.

A drawback of known scoring or crush cut arrangements is that during a crushing or scoring operation, and in particular also during set-up, misalignment between the axis of rotation of the blade and the axis of rotation of the anvil roll was often unavoidable due to the “rigid” alignment of these two axes. Such misalignment of the axis of rotation of the blade relative to the axis of rotation of the anvil results in a very quick failure of the blade edge. In particular, when a misalignment is present, i.e. when the axes are not parallel to one another, the blade tries to follow a spiral path along the face of the anvil roll, which, due to the aforementioned rigid alignment of the two axes, results in a sliding action, rather than a rolling action, of the blade on the anvil roll. In other words, a force acts on the blade that has a component that is perpendicular to the plane of the blade. This is very detrimental to the life of the blade.

It is therefore an object of the present application to provide a parallel alignment, and in particular a self-alignment, between the axis of rotation of the knife blade and the axis of rotation of the anvil roll so that the blade can roll smoothly on the surface of the anvil roll.

### BRIEF DESCRIPTION OF THE DRAWINGS

This object, and other objects and advantages of the present invention, will appear more clearly from the following specification in conjunction with the accompanying schematic drawings, in which:

FIG. 1 is a side view showing one exemplary embodiment of the inventive blade holder together with an anvil roll;

FIG. 2 is a front view of the arrangement of FIG. 1, showing the axis of rotation of the blade and the axis of rotation of the anvil roll;

FIG. 3 illustrates a misalignment situation; and

FIG. 4 is an enlarged view of FIG. 1.

### SUMMARY OF THE INVENTION

The device of the present application for aligning the axis of rotation of a blade with the axis of rotation of an anvil roll is characterized by a blade support that rotatably holds the blade, and by a pivot axis, wherein the blade support is pivotable relative to the pivot axis to effect a parallel alignment of the axis of rotation of the blade and the axis of rotation of the anvil roll, and wherein the pivot axis is disposed upstream of the contact point of the blade with the anvil roll as viewed in the direction of passage of material between the blade and the anvil roll.

As a consequence of the pivotability of the blade support of the present application relative to a pivot axis, the sliding action encountered with the heretofore known arrangements is prevented since with the device and method of the present application, any misalignment force that exists will move the blade into precise parallel alignment with the anvil roll due to the pivoting action. Thus, the blade undergoes a self alignment.

Further specific features of the present application will be described in detail subsequently.

### DESCRIPTION OF SPECIFIC EMBODIMENTS

Referring now to the drawings in detail, the side view of FIG. 1 is an overall view showing how a blade holder, which includes a blade holder body 10, cooperates with an anvil roll 11 to “crush”, and thus cut apart, material, such as paper, due to radial forces exerted by the cutting blade 12 of a blade support 13, which is movably held by the blade holder body 10, and the anvil roll 11, upon the material as it passes between the blade 12 and the anvil roll 11 in the direction of the arrow 14. It should be noted that the blade holder body 10 is fixedly mounted on a non-illustrated machine frame.

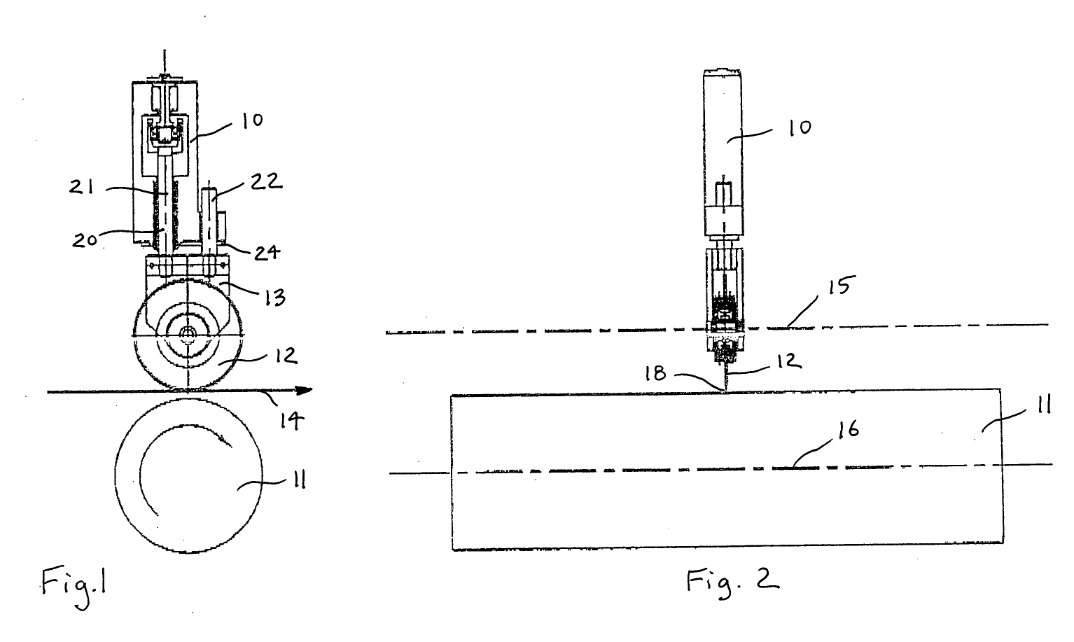

FIG. 2 illustrates the axis of rotation 15 of the blade 12 and the axis of rotation 16 of the anvil roll 11. The reference numeral 18 indicates the point of contact between the blade 12 and the anvil roll 11.

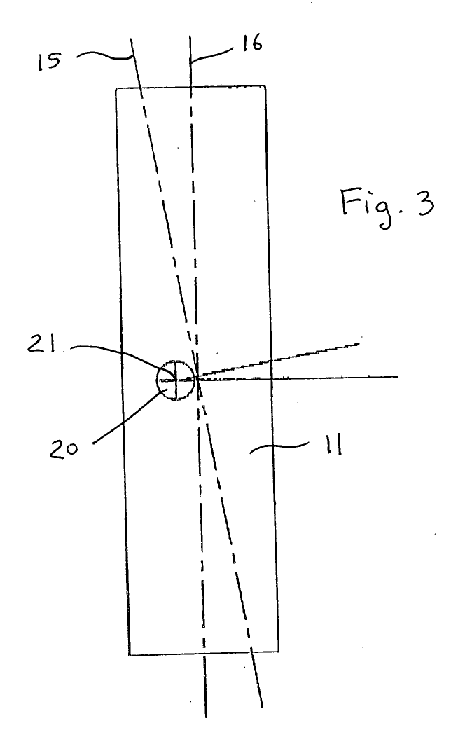

FIG. 3 illustrates the situation where the axis of rotation 15 of the blade 12 is misaligned, i.e. is not parallel, with the axis of rotation 16 of the anvil roll 11.

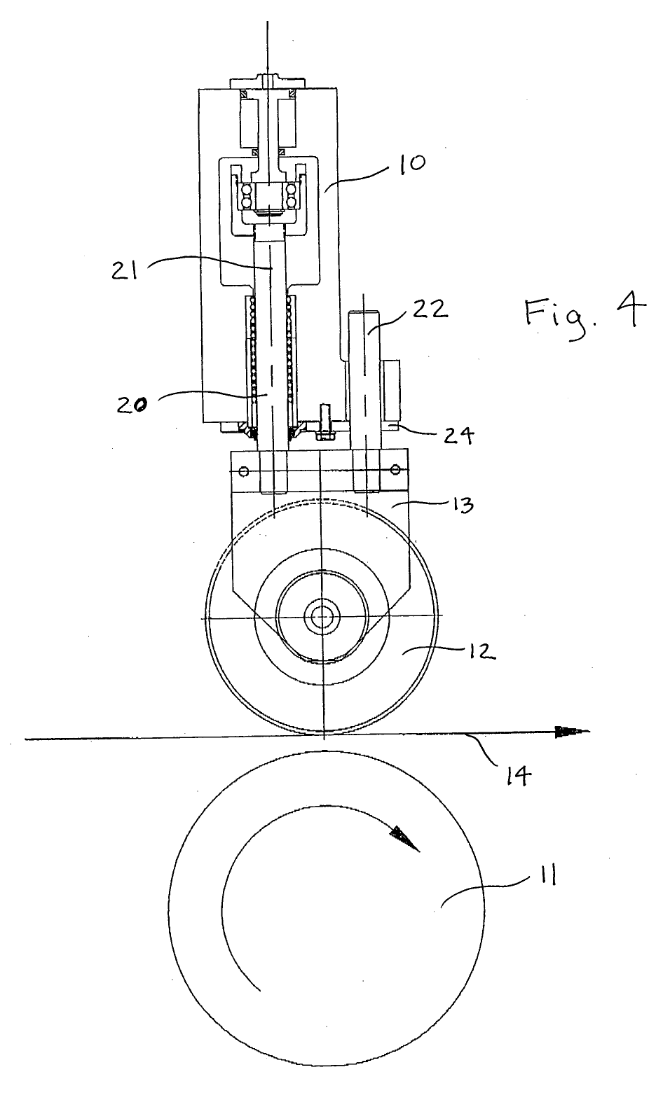

The inventive mechanism for aligning the axis of rotation 15 of the blade 12 with the axis of rotation 16 of the anvil 11, in other words to ensure that the axes 15 and 16 extend essentially parallel to one another, will now be described further with the aid of FIGS. 4 and 1. In particular, as can be seen from FIG. 4, the blade support 13, also known as a support head, together with the rotatably mounted blade 12, are pivotable about a fixed pivot shaft 20, which is mounted on the blade holder body 10. The axis 21 of the pivot shaft 20 is essentially perpendicular to the axis of rotation 16 of the anvil roll 11 (see FIGS. 1 and 3). It should be noted that the pivot shaft 20 could alternatively be mounted on the blade support 13, in which case the entire blade support 13 together with the blade 12 and the pivot shaft 20, are pivotable about the pivot axis 21. At any rate, the blade support 13 is pivotable relative to the pivot axis 21.

Alignment of the axis of rotation 15 of the blade 12 with the axis of rotation 16 of the anvil roll 11 is effected as follows. To begin with, the anvil roll 11 is caused to rotate. Thereupon, the blade 12 is brought into contact with the anvil roll 11, for example at the contact point 18 illustrated in FIG. 2. This causes the blade 12 to also rotate. If the axis of rotation 15 of the blade 12 is not aligned with the axis of rotation 16 of the anvil roll 11, the axial forces that act upon the blade 12 as the blade tracks on the anvil roll 11 will cause the blade 12, and hence the blade support 13, to pivot relative to the pivot axis 21 of the pivot shaft 20 until the axes 15 and 16 are aligned with one another and the blade 12 rolls smoothly on the anvil roll 11. From the foregoing explanation, it can be seen that the arrangement of the present application provides for a so-called self-alignment of the axis of rotation 15 of the blade 12 with the axis of rotation 16 of the anvil roll 11.

As can be seen from FIGS. 1, 3 and 4, a critical aspect of the present application is the fact that the pivot axis 21 is disposed upstream of the contact point 18 between the blade 12 and the anvil roll 11.

Although the blade 12 pivots together with the blade support 13 relative to the pivot axis 21, the blade 12 does not necessarily have to move in a radial direction toward or away from the anvil roll 11, but can also pivot relative to the blade holder body 10. At any rate, movement of the blade 12 toward or away from the anvil roll 11 can be effected in any convenient manner, for example via a pneumatic piston or by mechanical means. Furthermore, such radial movement of the blade 12, and in particular the blade support 13 therefor, can be guided by means of appropriate guide shafts disposed either on the blade holder body 10, or also on the blade support 13. For example, the optional guide shaft 22 can be mounted on the blade support 13 and can extend into a clearance hole or slot provided in the blade holder body 10. The aforementioned piston or the like can act on the pivot shaft 20, on the guide shaft 22, or otherwise on the blade support 13.

Once the correct alignment has been established as described above, an optional locking element (indicated by the reference numeral 24 in FIG. 1) can be provided in order to maintain the position of the axis of rotation 15 of the blade 12 relative to the axis of rotation 16 of the anvil roll 11 during subsequent operation, including disengagement and reengagement. Such a locking element limits the ability of the blade support 13 to pivot relative to the pivot axis 21, and can act, for example, on the guide shaft 22, e.g. by applying pressure thereto.

The present invention is, of course, in no way restricted to the specific disclosure of the specification and drawings, but also encompasses any modifications within the scope of the appended claims.

What I claim is:

1. A device for aligning the axis of rotation of a blade parallel to the axis of rotation of an anvil roll, comprising:
a blade holder body;
a blade support for rotatably holding the blade; and
a pivot shaft mounted on said blade holder body, or on said blade support, and having a pivot axis, wherein said blade support is pivotable relative to said pivot axis to effect alignment of the axis of rotation of the blade parallel to the axis of rotation of the anvil roll, and wherein said pivot axis is disposed essentially perpendicular to the axis of rotation of the anvil roll and upstream of a contact point of said blade with the anvil roll as viewed in a direction of passage of material between said blade and the anvil roll.

2. A device according to claim 1, wherein said pivot shaft is mounted on said blade holder body and said blade support is pivotable about said pivot shaft.

3. A device according to claim 1, wherein said blade is radially or pivotably movable within said blade holder body toward and away from the anvil roll.

4. A device according to claim 1, wherein blocking means are provided to prevent or restrict relative movement between said blade support and said pivot shaft.

5. A device according to claim 1, wherein the anvil roll is a rotatably driven anvil roll.

6. A method of aligning the axis of rotation of a blade parallel to the axis of rotation of an anvil roll, including the steps of:
providing a blade support that rotatably holds the blade;
providing a pivot axis that extends essentially perpendicular to the axis of rotation of the anvil roll and is disposed upstream of a contact point of the blade with the anvil roll;
mounting the blade support such that it is pivotable relative to the pivot axis;
rotating the anvil roll; and
providing contact between the blade and the anvil roll to cause the blade to roll on the anvil roll, wherein if the axis of rotation of the blade is not aligned in parallel to the axis of rotation of the anvil roll, the blade support pivots relative to the pivot axis to effect alignment of the axis of rotation of the blade parallel to the axis of rotation of the anvil roll.
